(19) United States
(12) Patent Application Publication
(10) Pub. No.: US 2010/0119199 A1
(43) Pub. Date: May 13, 2010

(54) REDUCED SIZE FIBER OPTIC PROBE USING MULTIPLE INCIDENT ANGLES

(75) Inventors: Daiichiro Tanaka, Greer, SC (US); Mingming Duan, Spartanburg, SC (US); Takashi Tsumanuma, Sakura-shi (JP); Sean Foley, Simpsonville, SC (US); Tomoaki Toriya, Yotsukaido-shi (JP); Tetsuya Ishii, Yachimata-shi (JP)

Correspondence Address: SUGHRUE MION, PLLC, 2100 PENNSYLVANIA AVENUE, N.W., SUITE 800, WASHINGTON, DC, 20037, US

(73) Assignee: AFL TELECOMMUNICATIONS LLC, Spartanburg, SC (US)

(21) Appl. No.: 12/444,324

(22) PCT Filed: Jul. 30, 2008
(86) PCT No.: PCT/US08/71614

§ 371 Date: Apr. 3, 2009

Related U.S. Application Data
(60) Provisional application No. 60/952,768, filed on Jul. 30, 2007.

(51) Int. Cl. G02B 6/04

(52) U.S. Cl. 385/115; 264/1.28

(57) ABSTRACT

A method for manufacturing an optical probe which uses optical fibers arranged in parallel which can be easily bent by application of a heat source to improve the performance of the optical probe. The bend may be created by application of heat by a heat source and then forcing a change in the shape of the optical probe. Alternatively, an optical probe may be bent in room temperature and then by applying heat from a heat source, a bend can be created in the optical probe.

### CROSS-REFERENCE TO RELATED APPLICATION

This application claims priority from U.S. Provisional Application No. 60/952,768 filed on Jul. 30, 2007 in the United States Patent Office, the disclosure of which is incorporated herein in its entirety by reference.

### BACKGROUND OF THE INVENTION

1. Field of the Invention

The present invention relates to an optical probe and more particularly, to a method for manufacturing a probe which uses optical fibers arranged in parallel which can be easily bent by application of a heat source to improve the performance and reduce the diameter of the optical probe.

2. Description of the Related Art

Industry has been working on varying angles of light incident to various materials to obtain information about optical properties of materials at different depths from surfaces for sensing or diagnostic purposes. For Example, Early Cervical Cancer Detection is based on looking at light interactions at different depths of epithelial layer of tissue. Generally, different incident angles of light illumination and collection are employed to look at different depths in tissue. Numerous automated diagnostic methods have been developed which allow faster, more effective patient management and potentially further reduce mortality. Accordingly, in much of the related technology specific focus is on the epithelial layer of tissue which is 300 to 500 microns thick where it is believed that cancer can be detected at the very onset. U.S. Pat. No. 7,202,947 is an example of this work. Earlier related patents on the same topic include U.S. Pat. Nos. 5,991,653 and 5,697,373.

Many diagnostic techniques which use varying incident angles of light require the use of a probe, In some cases, the diameter of the probe must be small enough to fit into areas that are obstructed, difficult to access or when employed for medical purposes, it must be small enough to fit into areas where if the size is not adequately small enough, the prove may potentially give the patient discomfort or increase the potential for harm. Typical optical probes found in industry are relatively large in diameter because the fiber must be bent mechanically to achieve the required incident angle. This bend must be of sufficient radius to prevent the optical fiber from breaking. Additionally, the surface atypical probes are often stainless steel or some other metal material and highly reflective. One method used to reduce the reflection of the stainless steel surface is to use blackened or anti-reflective tapes or coatings. However, these tapes or coatings are generally not suitable for use in clinical use or other high purity environments. Additionally, probes used in the related art have had a significant spacing between fibers. This separation distance can make it hard to capture adequate light in fibers with a high angle of incidence to the probe tip because these fibers have an angled facet which presents significant optical losses between the fiber and the adjacent medium.

### SUMMARY OF THE INVENTION

Accordingly, the present invention has been made to solve the above-mentioned problems occurring in the related art, and an aspect of the present invention is to provide a method for manufacturing a medical optical probe which uses an optical fibers arranged in parallel Which can be easily bent by application of heat by a heat source to improve the performance of the medical probe

Additional advantages, aspects, and features of the invention will be set forth in part in the description which follows and in part will become apparent to those having ordinary skill in the art upon examination of the following or may be learned from practice of the invention.

In an aspect of the present invention, an optical probe comprising arranging a plurality of optical fibers substantially in parallel and at least one of the plurality of fibers contains a bent portion. The bent portion of the fiber is towards the end of the probe.

In another aspect of the present invention, the plural optical fibers are fixed in resin in the optical probe.

In another aspect of the present invention, the plural optical fibers are fixed on a substrate in the resin, parallel inside an outer case, wherein said plural optical fibers are fixed in V-groves in the substrate.

In another aspect of the present invention, wherein the resin is a low-reflective epoxy.

In another aspect of the present invention, wherein said bent portion is bent by heating up the bent portion by a heat source. The heat source may apply heat ranging from 300 to 1400 degrees centigrade.

In another aspect of the present invention, the bent portion is bent by first bending an optical probe in room temperature and then applying the heat source to the bent region.

In another aspect of the present invention, the bent portion is bent by first applying the heat source to the bent region and then applying force to the optical probe.

In another aspect of the present invention, the bent portion is bent at angle of 0 to 45 degrees.

In another aspect of the present invention, the bent portion is bent at a predetermined angle by using a bending device.

In another aspect of the present invention, the outer casing of said optical probe contains angled portions towards the end the optical probe.

In another aspect of the present invention, the angled portions of said optical fibers have less than 200 μm sparing from one of a plurality of optical fibers and straight portions of said optical fibers have a 200 to 400 μm spacing from one of a plurality of optical fibers.

### BRIEF DESCRIPTION OF THE DRAWINGS

The above and other objects, features and advantages of the present invention will be apparent from the following detailed description taken in conjunction with the accompanying drawings, in which:

FIGS. 1a and 1b illustrate a method to bend a portion of an optical fiber according to an exemplary embodiment of the present invention;

FIG. 2 illustrates an optical probe which contains optical fibers according to an exemplary embodiment of the present invention;

FIG. 3 illustrates an optical probe which contains optical fibers according to another exemplary embodiment of the present invention;

FIG. 4 illustrates a trimmed probe age present at the end of the optical probe according to an exemplary embodiment of the present invention;

FIGS. 5a and 5b illustrate a method to bend a portion of an optical fiber according to another exemplary embodiment of the present invention;

FIGS. 6 and 7 illustrate a device and the use of the device to precisely bend an optical fiber according to an exemplary embodiment of the present invention;

FIG. 8 illustrates another device that can be used to precisely bend an optical fiber according to another exemplary embodiment of the present invention.

### DESCRIPTION OF EXEMPLARY EMBODIMENTS

Advantages and features of the present invention and methods of accomplishing the same may be understood more readily by reference to the following detailed description of the exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

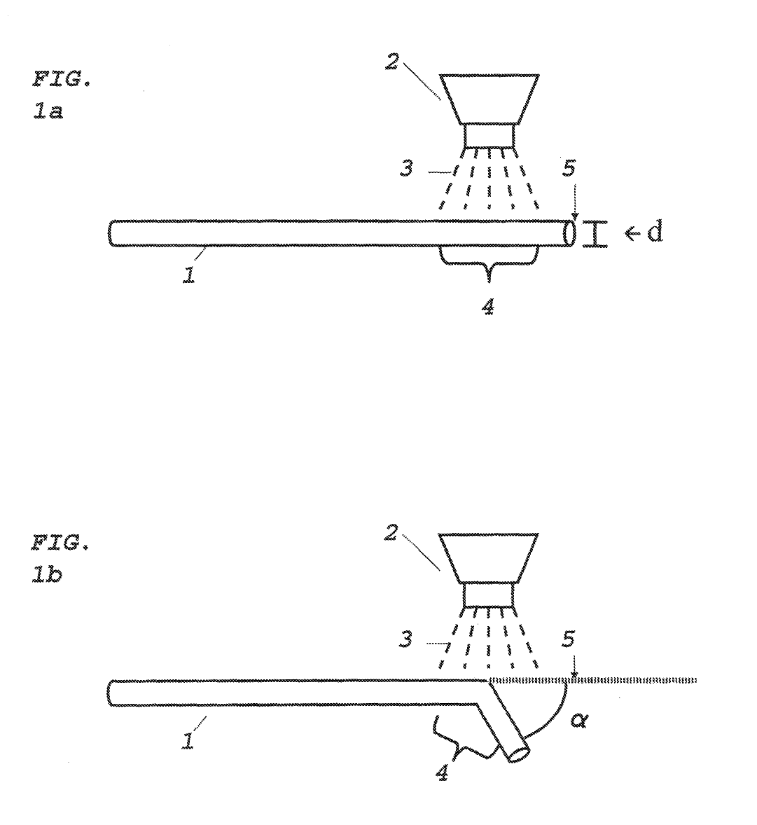

FIGS. 1a and 1b are views illustrating an optical fiber according to an exemplary embodiment of the present invention. In FIG. 1a, the optical fiber 1 typically has a diameter d of 125 μm. One of ordinary skill in the art would comprehend that concepts of the present invention can be implemented with varying diameters d. In this exemplary embodiment, a heat source 2 applies heat 3 to region 4 of the optical fiber 1. Region 4 is preferably towards the end of the optical fiber 1. The heat source 2 may include a CO₂ LASER, electric heater, infrared furnace and a flame. The temperature of the heat 3 being applied to the fibers in section 4 of the optical fiber 1 is typically at least 300 degrees centigrade. However, it is preferred that a temperature from 300 degrees to 1400 degrees centigrade is applied, The temperature of the heat 3 that is applied varies on the glass composition of the fiber 1. The specific temperature of the heat is not critical to the invention; rather it must simply be sufficient to create a permanent bend in the fiber 1.

FIG. 1a illustrates that the heat source 2 applies heat 3 at a temperature of 1400 degrees centigrade to region 4 of the optical fiber 1. If only heat 3 and no other physical three is applied on the optical fiber 1, there is no change in the shape of the optical fiber 1. In such a scenario, the optical fiber 1 at region 4 merely heats up and cools off. Therefore, the optical fiber 1 retains its shape pre-application of heat 3 from heat source 2 and post-application of heat 3 from heat source 2.

As stated above, mere application of heat 3 by a heat source 2 does not lead to the change of shape of the optical fiber 1. Therefore, to cause a bend in the optical fiber 1 in region 4 to which the heat 3 is being applied, a downward force 5 is applied towards the far end of the optical fiber 1.

FIG. 1b, illustrates the result of the application of the force 5 which causes a bend in the optical fiber 1 at region 4. After, the optical fiber 1 is bent to an angle α of a desired amount, the application of the heat 3 by the heat source 2 is halted. As the optical fiber 1 cools, it retains its bent shape. Accordingly, an optical fiber 1 can be reshaped without having to use any other form of support or utensils to preserve that shape. Thereafter, the optical fiber 1 has a straight portion 21 and an angled portion 22.

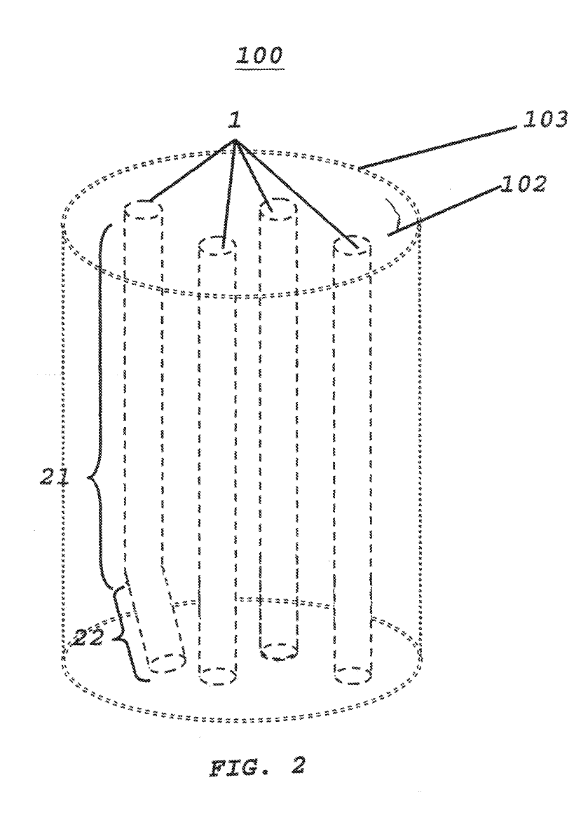

FIG. 2, illustrates an optical probe 100 using multiple optical fibers 1 bent according to an exemplary embodiment of the present invention. Four optical fibers 1 are arranged substantively in parallel to form the optical probe 100. One of the optical fibers 1 contains an angled portion 22. Some of these optical fibers 1 are used for light illumination while some of them are used for detecting light. These optical fibers 1 are fixed in a resin 102 inside an outer case 103. In the exemplary embodiment illustrated in FIG. 2, the outer case 103 is a stainless steel pipe, Furthermore, any curable resin may be used for the resin 102, but low reflection material is preferable. One of ordinary skill in the art would comprehend that materials with similar properties can be used to function as the resin 102.

Additionally, the outer surface of the optical probe 100 may use non-reflective epoxies rather than a metal probe face (not illustrated). Therefore, noise generated by multi reflection between the probe surface and tissue may be reduced.

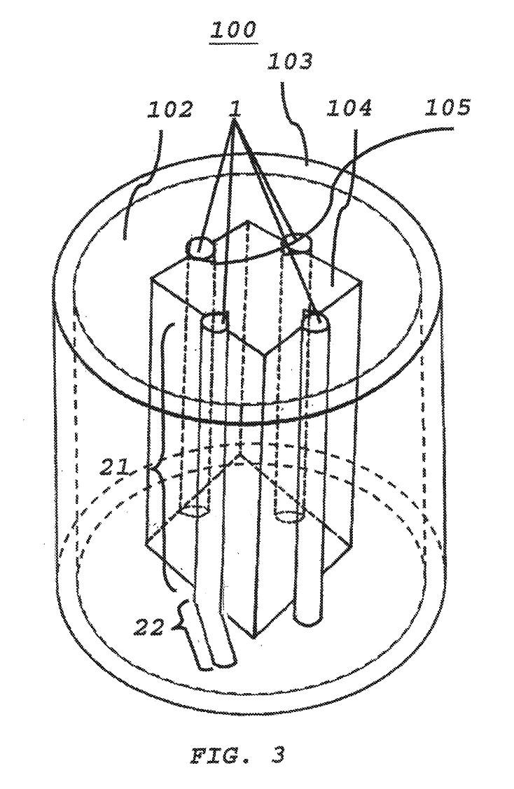

Further, optical fibers 1 can also be fixed within a substrate in the resin 102. FIG. 3 illustrates according to another exemplary embodiment of the present invention, four optical fibers 1 fixed on a substrate 104 with four V-grooves 105. One of the optical fibers 1 which has been bent applying any of the methods provided in the exemplary embodiments of the present invention, contains a straight portion 21 and an angled portion 22. The straight portion 21 is aligned in a corresponding V-Groove 105, while the angled portion 22 juts out. The presence of these V-Grooves 105 allows for precise fiber arrangement. Once of ordinary skill in the art would comprehend that the substrate 104 may contain an unlimited amount of V-Grooves 105 and the substrate 104 is not limited to the shape illustrated in FIG. 3. Furthermore, in this exemplary embodiment, in sections of the optical probe 100 which contains angled portions 22 of optical fibers 1, there is a 200 μm spacing between the optical fibers 1, while portions of the optical probe 100 with straight portions of fiber 1 have a 200 to 400 μm spacing between the optical fibers 1. Due to the lessened spacing between the optical fibers 1, the desired bend is achieved over a wide spectrum of diameters including a relatively smaller relative diameter of 3 mm. This allows for prevention of “beam” type stresses or breaking forces being applied to the fiber.

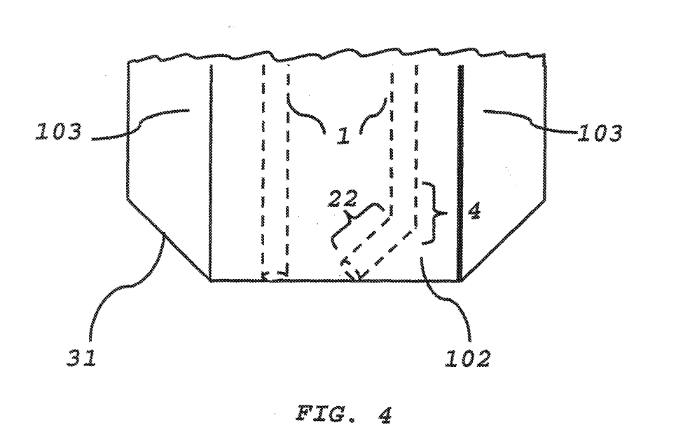

FIG. 4 is an illustration of a side view trimmed probe edge 31 present at one end of optical probe 100 according to an exemplary embodiment of the present invention. As discussed above one of the optical fibers 1 has the bent region 4 and therefore the angled portion 22 towards the end of the optical probe 100. As illustrated in FIG. 4, the outer casing 103 contains a trimmed probe edge 31 towards the end of the optical probe 100. As the optical probe 100 is round, the trimmed probe edge 31 goes all the way around as well. The trimmed probe edge 31 is at a sharp angle which aids in reducing reflective profile of a stainless steel tube edge.

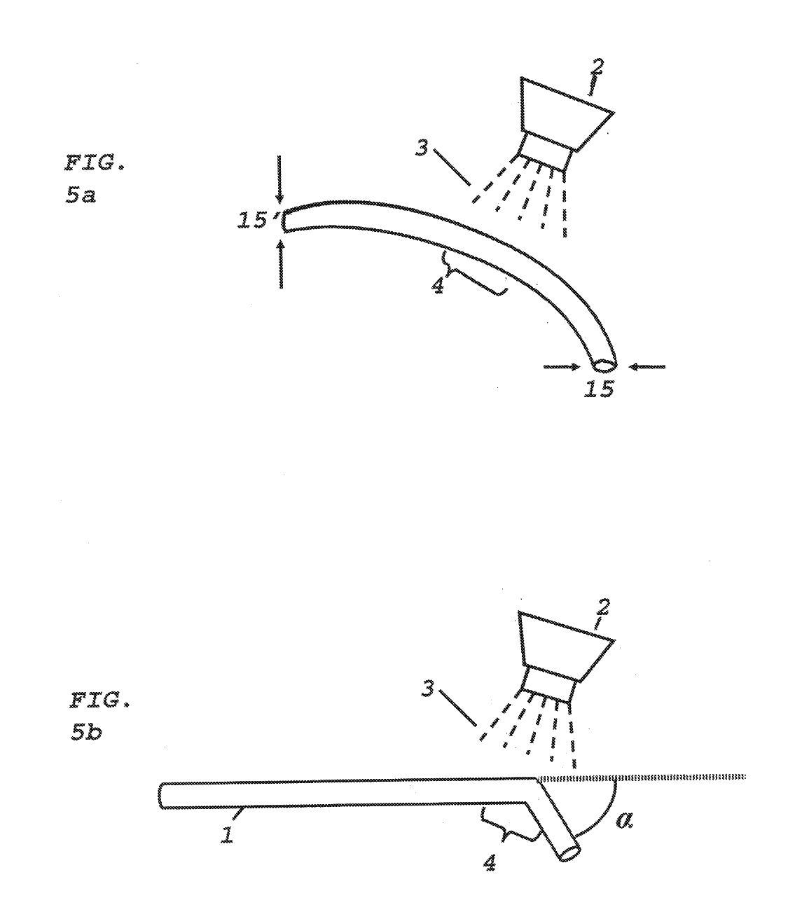

FIGS. 5a and 5b, illustrate another exemplary embodiment of the present invention. In FIG. 5a, the optical fiber 1 is bent in room temperature by application of forces 15 and 15′ at the respective ends. Thereafter, a heat source 2 applies heat 3 to a region 4 of the optical fiber 1. The region 4 is preferable closer to one end of the optical probe 1. Region 4 of the optical fiber 1 which is exposed to heat 3 from the heart source 2 become soft and the region 4 bends in accordance with angles depending on forces 15 and 15′ that are applied to the respective ends. FIG. 5b illustrates the result of the application of the respective threes 15 and 15′, as well as heat 3 from the heat source 2, resulting in a bend with approximately an angle α of 30 degrees being created.

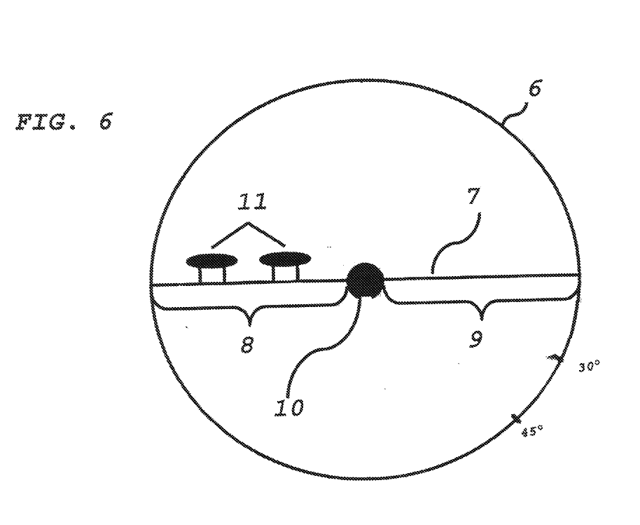

However, the application of the present inventions as presented in the exemplary embodiments of FIGS. 1 and 5 does not necessarily lead to an accurate selection of the angle of the bend of the optical fiber 1. As the optical fiber 1 is used for sensitive diagnosis, any changes in shape must be extremely precise. For this purpose, FIG. 6 illustrates a plate which can be used to precisely bend the optical probe at a particular angle α according to another exemplary embodiment of the present invention.

FIG. 6 displays a plate 6 which contains a mechanism to precisely choose an angle of the bend in the optical fiber 1. The plate 6 contains a guide 7 with a fixed portion 8 and a movable portion 9. The fixed portion and the movable portion are connected at a pivot point 10. The plate displays varying angles to which a user can move the outside edge of the movable portion 9. Accordingly, in an exemplary embodiment if a user wants a 30 degree angle of bend, the user moves the outside edge to 30 degrees and locks the movable portion at that angle through a locking mechanism (not illustrated). Furthermore, the fixed portion 7 contains latches 11 or another locking mechanism to secure the optical fiber 1 to the guide 7.

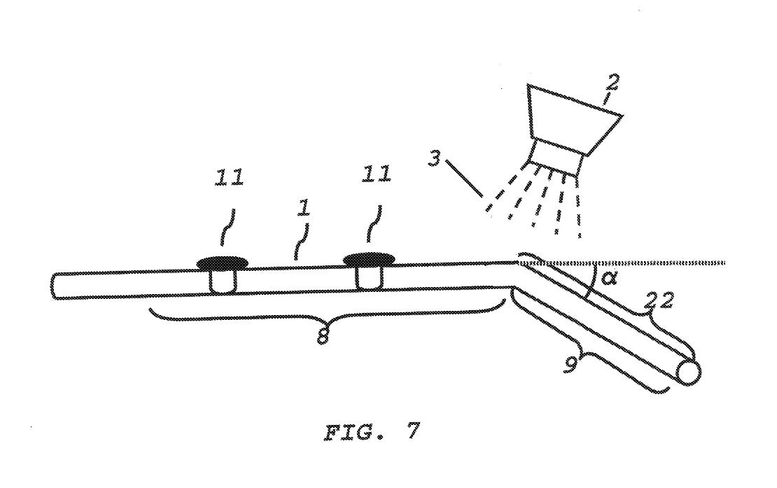

FIG. 7 illustrates the plate 6 of FIG. 6 being utilized to bend the optical fiber 1 so that the optical fiber 1 has a bend angle α of 30 degrees. An optical fiber 1 is placed on the plate 6 and secured on the fixed portion 8 of the guide 7 using latches 11, A user previously sets the moving portion 9 to be at an angle α of thirty degrees. Thereafter, a heat source 2 applies heat 3 at a region 4 of the optical fiber 1 which straddles the pivot point 10. Due to the heat 3, the optical fiber 1 at region 4 softens and when a force 5 is applied downwards, a bend is created in the optical fiber 1 at region 4. A force 5 is continually applied till the angled portion 22 of the optical fiber 1 is completely flat against the movable portion 9 of the guide 7. Thereafter, as soon as the fiber 1 is no longer exposed to the heat source 2, the optical fiber 1 begins to cool off. As the optical fiber 1 cook off, it retains its shape autonomously, therefore preserving the bent shape of the optical fiber 1 at exactly thirty degrees.

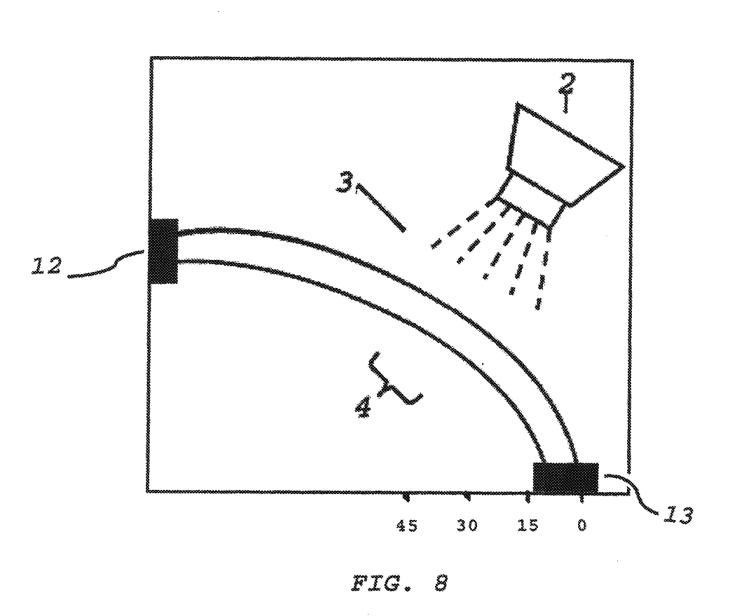

FIG. 8 illustrates another mechanism to precisely bend an optical fiber 1 according to an exemplary embodiment of the present invention. In this exemplary embodiment, the optical fiber 1 is first bent in room temperature and then a heat source 2 applies heat 3 to a region 4 of the optical fiber 1 to cause a bending of the optical fiber 1 at region 4. The forces that are applied to bend the optical fiber 1 in room temperature are applied by Force Applying Devices (FADs) 12 and 13. FAD 12 may either be fixed or movable in the vertical direction. FAD 13 may further be fixed or movable in the horizontal direction. FADs 12 and 13 can not only apply the forces to cause a bend but may also independently hold the optical fiber 1. Previous calculations allow the user to arrange the positions of the FADs 12 and 13 depending on a desired angle α and on the position of the optical fiber 1 where the user desires the bend (therefore, the region 4) to occur.

One of ordinary skill in the art would comprehend that the structure can be slightly altered to implement the principles of the present invention to produce similar results.

In another exemplary embodiment of the present invention in which the heat source 2 of FIGS. 1 and 5-8 is a flame, the flame is formed by a combination of CₓH_{y}O_{z} and Oxygen. The x, y and z in CₓH_{y}Oₓ each represent respective integer values including zero.

As described above, according to the exemplary embodiment of the present invention, a medical probe with a narrow width, made of non-reflective material, is bent accurately, thus the performance of the medical probe in clinical studies can be improved.

Although exemplary embodiments of the present invention have been described for illustrative purposes, those skilled in the art will appreciate that various modifications, additions and substitutions are possible, without departing from the scope and spirit of the invention as disclosed in the accompanying claims. The foregoing embodiments are merely exemplary and are not to be construed as limiting the present invention. Therefore, the scope of the present invention should be defined by the accompanying claims and their legal equivalents.

What is claimed is:

1. A method for fabricating an optical probe comprising:
arranging a plurality of optical fibers substantially in parallel substantively;
wherein at least one of said plurality of fibers contains a bent portion.

2. A method for fabricating an optical probe as recited in claim 1, wherein said bent portion is towards the end of the probe.

3. A method for fabricating an optical probe as recited in claim 1, wherein said plural optical fibers are fixed.

4. A method for fabricating an optical probe as recited in claim 3, wherein said plural optical fibers are fixed in resin.

5. A method for fabricating an optical probe as recited in claim 5, wherein said plural optical fibers are fixed on a substrate in the resin and are parallel inside an outer case.

6. A method for fabricating an optical probe as recited in claim 5, wherein said plural optical fibers are fixed in V-groves in the substrate.

7. A method for fabricating an optical probe as recited in claim 4, wherein said resin is a low-reflective epoxy.

8. A method for fabricating an optical probe as recited in claim 1, wherein said bent portion is bent by using a heat source.

9. A method for fabricating an optical probe as recited in claim 8, wherein said bent portion is bent by first bending an optical probe and then applying the heat source to the bent region.

10. A method for fabricating an optical probe as recited in claim 8, wherein said bent portion is bent by first applying the heat source to the bent region and then applying force to the optical probe.

11. A method for fabricating an optical probe as recited in claim 10, wherein said bent portion is bent at angle of between 0 to 45 degrees.

12. A method for fabricating an optical probe as recited in claim 11, wherein said bent portion is bent at a predetermined angle by using a bending device.

13. A method for fabricating an optical probe as recited in claim 5, wherein the outer casing of said optical probe contains angled portions towards the end the optical probe.

14. A method for fabricating an optical probe as recited in claim 5, wherein angled portions of said optical fibers have less than 200 μm spacing from one of a plurality of optical fibers and straight portions of said optical fibers have a 200 to 400 μm spacing from one of a plurality of optical fibers.

15. A method for fabricating an optical probe as recited in claim 8, wherein the heat source applies heat of at least 300 degrees centigrade.

16. A method for fabricating an optical probe as recited in claim 8, wherein the heat source applies heat from 300 degrees to 1400 degrees centigrade.

17. An optical probe comprising:
a plurality of optical fibers arranged substantially in parallel substantively;
wherein at least one of said plurality of optical fibers transmits light from a light source;
wherein at least one of said plurality of optical fibers transmits light for detecting light; and
wherein at least one of said plurality of fibers contains a bent portion.

18. An optical probe as recited in claim 17, wherein said bent portion is towards the end of the probe.

19. An optical probe as recited in claim 18, wherein said plural optical fibers are fixed.

20. An optical probe as recited in claim 19, wherein said plural optical fibers are fixed in resin.

21. An optical probe as recited in claim 20, wherein said plural optical fibers are fixed on a substrate in the resin and are parallel inside an outer case.

22. An optical probe as recited in claim 21, wherein said plural optical fibers are fixed in V-groves in the substrate.

23. An optical probe as recited in claim 20, wherein said resin is a low-reflective epoxy.

24. An optical probe as recited in claim 18, wherein said bent portion is bent at angle of between 0 to 45 degrees.

25. An optical probe as recited in claim 21, wherein the outer casing of said optical probe contains angled portions towards the end the optical probe.

26. An optical probe as recited in claim 28, wherein angled portions of said optical fibers have less than 200 μm spacing from one of a plurality of optical fibers and straight portions of said optical fibers have a 200 to 400 μm spacing from one of a plurality of optical fibers.
